(19) United States
(12) Patent Application Publication
(10) Pub. No.: US 2014/0114539 A1
(43) Pub. Date: Apr. 24, 2014

(54) VEHICULAR POWER SOURCE CONTROL APPARATUS

(71) Applicant: DENSO CORPORATION, Kariya-city (JP)

(72) Inventors: Yasuto Ando, Kariya-city (JP); Toru Nada, Inazawa-city (JP); Yuji Nonoyama, Kariya-city (JP)

(73) Assignee: DENSO CORPORATION, Kariya-city (JP)

(21) Appl. No.: 14/033,901

(22) Filed: Sep. 23, 2013

(30) Foreign Application Priority Data
Oct. 24, 2012 (JP) 2012-234842

(51) Int. Cl. F02D 35/00

(52) U.S. Cl. CPC F02D 35/00
USPC 701/51

(57) ABSTRACT

A vehicular power source control apparatus includes: two detection devices selected from a door open and close detection device, a seating detection device, a belt detection device, a gripping detection device, a brake detection device, or a shift lever position detection device; and a power source control device to turn on the power source when a power source turn-on condition provided by two predetermined detection results is established. The two predetermined detection results are selected from detection results that the door is closed, the driver sits down on the driver seat, the driver fastens the seat belt, the driver grips the steering wheel, the driver puts on the brake pedal, or the shift lever position of the vehicle is a parking position or a neutral position.

### CROSS REFERENCE TO RELATED APPLICATION

This application is based on Japanese Patent Application No. 2012-234842 filed on Oct. 24, 2012, the disclosure of which is incorporated herein by reference.

### TECHNICAL FIELD

The present disclosure relates to a vehicular power source control apparatus mounted on a vehicle for controlling a power source of the vehicle.

### BACKGROUND

Recently, a control method for easily starting an engine of a vehicle such as a car and for limiting an unexpected start of the engine is proposed. For example, JP-A-2003-301764 teaches an apparatus that turns on an accessory switch and an ignition switch in order to be in an operation state when the apparatus detects pushing of a brake pedal via a brake pedal switch, and detects that an authenticated mobile device is disposed in a compartment of the vehicle in a case where a push button type switch is pushed down.

However, in the above apparatus, a driver of the vehicle can not turn on a power source of the vehicle unless the driver executes a special operation such as an operation of pushing down the switch, which is different from a necessary operation of driving the vehicle.

### SUMMARY

It is an object of the present disclosure to provide a vehicular power source control apparatus for turning on a power source of a vehicle without performing a specific operation.

According to an example aspect of the present disclosure, a vehicular power source control apparatus mounted on a vehicle and controlling a power source of the vehicle includes: at least two detection devices selected from a door open and close detection device for detecting whether a door of the vehicle is opened or closed, a seating detection device for detecting whether a driver of the vehicle sits down on a driver seat, a belt detection device for detecting whether the driver fastens a seat belt, a gripping detection device for detecting whether the driver grips a steering wheel, a brake detection device for detecting whether the driver puts on a brake pedal, or a shift lever position detection device for detecting a shift lever position of the vehicle; and a power source control device for controlling the power source to turn on when a power source turn-on condition is established. The power source turn-on condition is provided by a combination of at least two predetermined detection results, which correspond to the at least two detection devices. The at least two predetermined detection results of the power source turn-on condition are selected from a detection result of the door open and close detection device such that the door is closed, a detection result of the seating detection device such that the driver sits down on the driver seat, a detection result of the belt detection device such that the driver fastens the seat belt, a detection result of the gripping detection device such that the driver grips the steering wheel, a detection result of the brake detection device such that the driver puts on the brake pedal, or a detection result of the shift lever position detection device such that the shift lever position of the vehicle is a parking position or a neutral position.

In general, the driver closes the door, sits down on the driver seat, fastens the seat belt, grips the steering wheel, and puts on the brake pedal for safety, which are necessary actions for driving the vehicle. Further, in this case, the shift lever position is the parking position or the neutral position. In the above apparatus, when at least two predetermined detection results are obtained among these actions, the power source turn-on condition is established, so that the power source control device controls the power source to turn on. Accordingly, even if the driver does not perform a special operation for turning on the power source, the power source automatically turns on. Further, since the power source turn-on condition is provided by a combination of at least two detection results, a failure that the power source accidentally turns on against the driver's intention is appropriately restricted.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a perspective view of a compartment of a car while viewing a driver seat from an obliquely rear side;

FIG. 2 is a diagram showing a perspective view of the compartment of the car while viewing a front passenger seat;

FIG. 3 is a block diagram showing a control system of the car;

FIG. 4 is a block diagram showing a power source system of the car;

FIG. 5 is a flowchart showing a process of a control device in the control system;

FIG. 6 is a diagram showing a state transition diagram corresponding to the process of the control device; and

FIG. 7 is a diagram showing a state transition diagram corresponding to a process of the control device according to another embodiment.

### DETAILED DESCRIPTION

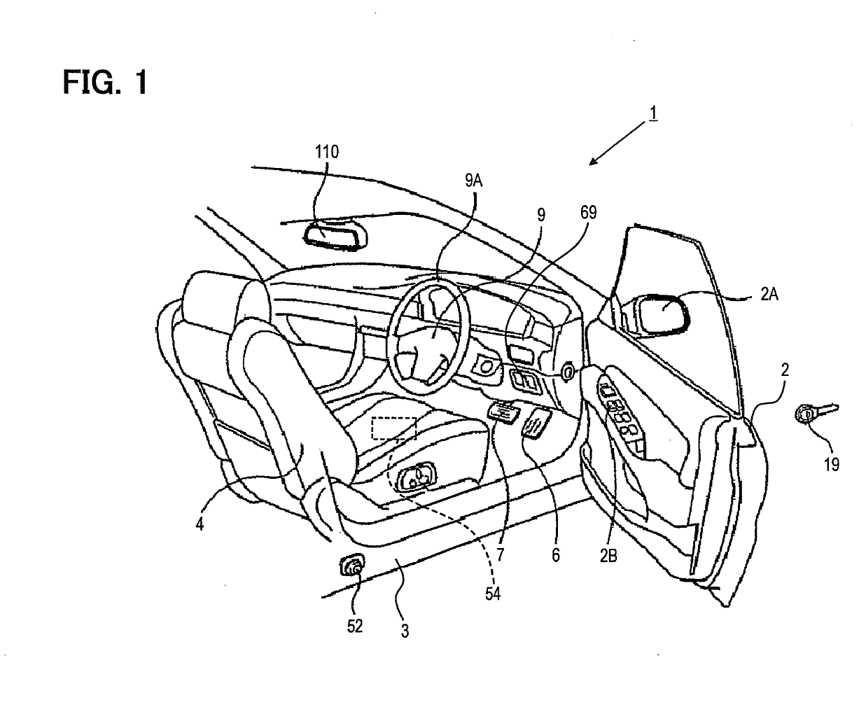

An example embodiment of the present disclosure will be explained with respect to the drawings. In the embodiment, a vehicular power source control apparatus is mounted on a car 1 as a vehicle. As shown in FIG. 1, the car 1 includes a door 2, which is capable of opening and closing, and has a door mirror 2A arranged on an outside of the door 2. A door open/close detection device 52 is arranged on a body 3. The device 52 detects the open/close of the door 2. Various switches 2B such as a switch for opening and closing a window are arranged on an inside of the door 2.

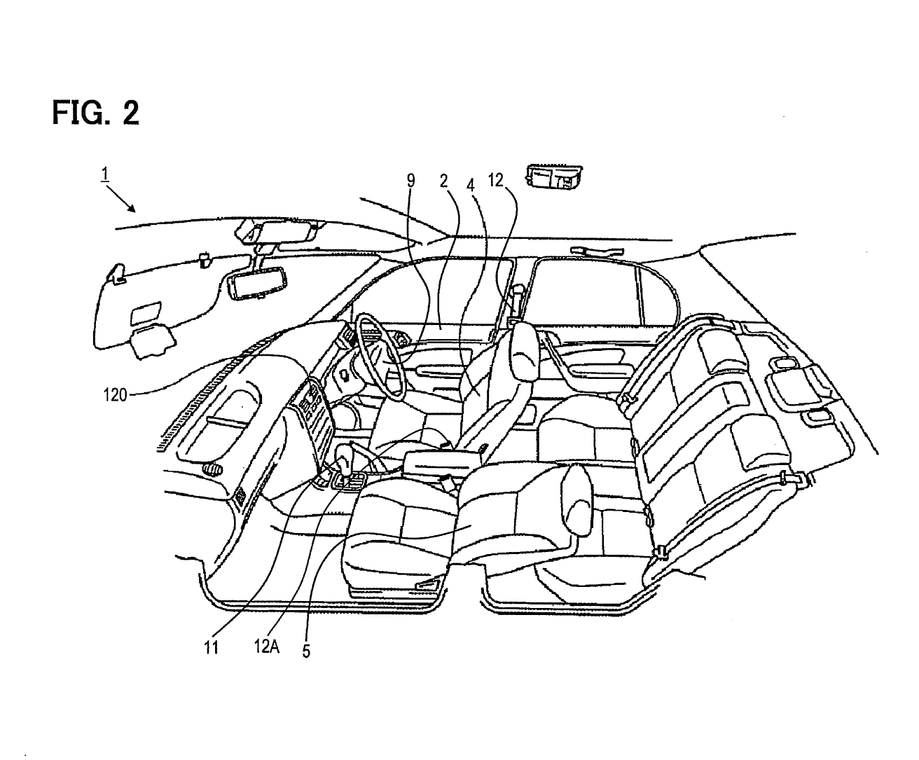

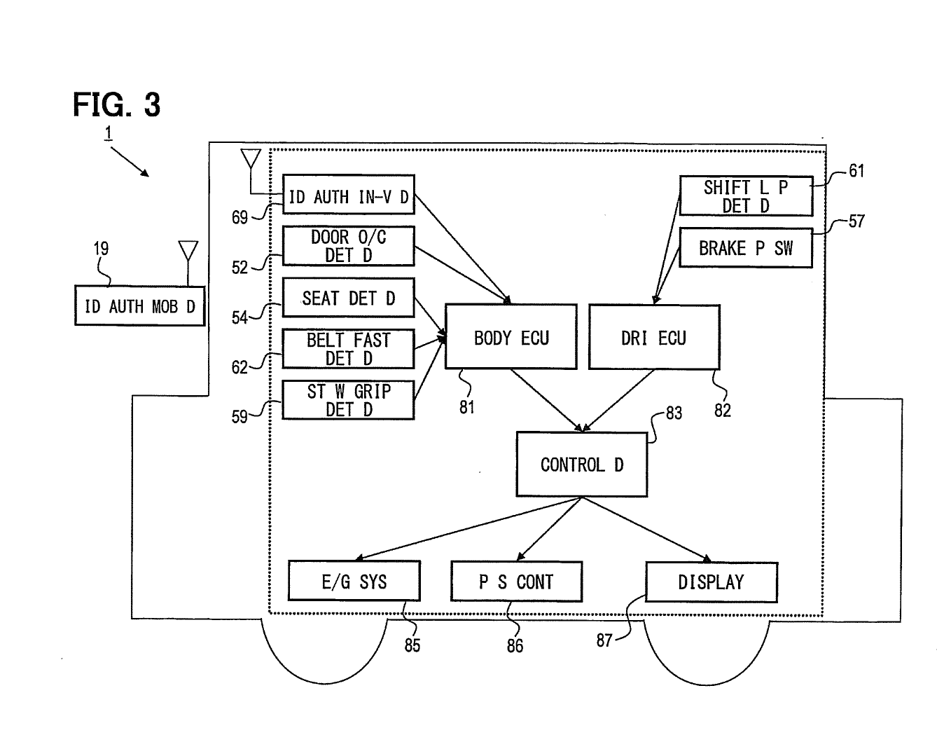

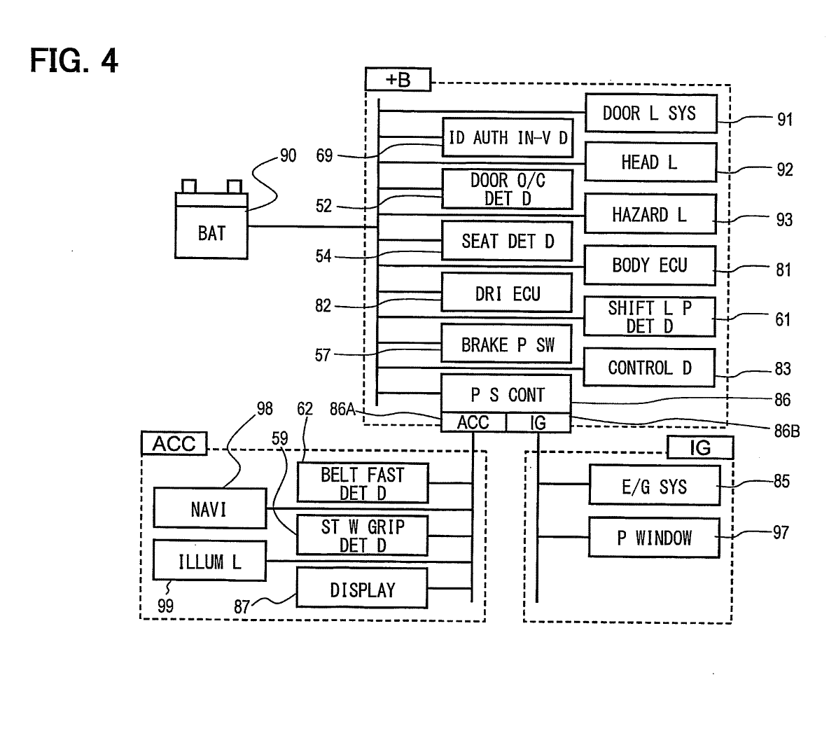

A driver seat 4 and a front passenger seat 5 are arranged on a front side of the compartment of the car 1, as shown in FIG. 2. An acceleration pedal 6, a brake pedal 7 and a steering system 9 are arranged on a front side of the driver seat 4. A seating detection device 54 for detecting a seating of the driver is arranged in a seating portion of the driver seat 4. A brake pedal switch 57 for detecting a pushing state of a brake pedal 7 is arranged on the brake pedal 7, as shown in FIGS. 3 and 4. Further, a steering wheel gripping detection device 59 for detecting a gripping state of a steering wheel 9A is arranged in a steering system 9, as shown in FIGS. 3 and 4.

Here, as shown in FIG. 2, a shift lever 11 is arranged between the driver seat 4 and the front passenger seat 5. A shift lever position detection device 61 detects a position of the shift lever 11 as a shift position, as shown in FIGS. 3 and 4. A seat belt 12 for fixing the driver on the driver seat 4 has a top end, which is to be inserted into a buckle 12A so that the seat belt 12 is fastened. The buckle 12A is arranged adjacent to a passenger side of the driver seat 4. A belt fastening detection device 62 for detecting a fastening state of the seat belt 12, as shown in FIGS. 3 and 4. Further, as shown in FIG. 1, the driver brings an ID (identification data) authentication mobile device 19, which represents that the driver is a proper owner of the car 1. An ID (identification data) authentication in-vehicle device 69 for communicating with the ID authentication mobile device 19 and for authenticating the ID (identification data) of the ID authentication mobile device 19 is arranged in front of the driver seat 4. The ID authentication in-vehicle device 69 may be arranged on a rear view mirror 110 or the like.

Next, as shown in FIG. 3, in the control system of the car 1, the ID authentication in-vehicle device 69, the door open/close detection device 52, the seating detection device 54, the belt fastening detection device 62, and the steering wheel gripping detection device 59 are connected to a body ECU 81. Further, the shift lever position detection device 61 and the brake pedal switch 57 are connected to a driving ECU 82. The body ECU 81 is a group of ECUs relating to a vehicle equipment such as a door lock ECU, a window ECU, air conditioning ECU and an audio ECU. The driving ECU 82 is a group of ECUs relating to a drive of the vehicle such as an engine ECU, an automatic transmission (i.e., AT) ECU and a brake ECU. A control device 83 controls an engine system 85, a power source controller 86 and a display 87 based on various signals obtained by the body ECU 81 and the driving ECU 82.

A process relating to the power source controller 86, which is executed by the control device 83 will be explained. First, a function of the power source controller 86 will be explained with reference to FIG. 4. As shown in FIG. 4, the power source controller 86 is connected to a +B power source, which is supplied electricity from a battery 90 always. The controller 86 controls to supply electricity from the battery 90 to an accessory (ACC) power source 86A or an ignition power source 86B. When the electricity from the battery 90 is supplied to the accessory power source 86A, the accessory power source 86A is in an on-state. When the electricity from the battery 90 is supplied to the ignition power source 86B, the ignition power source 86B is in an on-state.

The +B power source is connected to the ID authentication in-vehicle device 69, the door open/close detection device 52, the seating detection device 54, the driving ECU 82, the brake pedal switch 57, the body ECU 81, the shift lever position detection device 61 and the control device 83 in addition to the power source controller 86. Further, the +B power source is connected to the door lock system 91, the head light 92 and a hazard light 93. Further, the ignition (IG) power source 86B is connected to the engine system 85, the power window 97 and the like. Further, the accessory power source 86A is connected to a vehicle navigation device 98 (not shown in FIGS. 1 and 2) and an illumination light 99 in addition to the belt fastening detection device 62, the steering wheel gripping detection device 59, and the display 87. The illumination light 99 illuminates a panel frame of an air conditioning system, which is mounted on a dash board 120 in FIG. 2, for example.

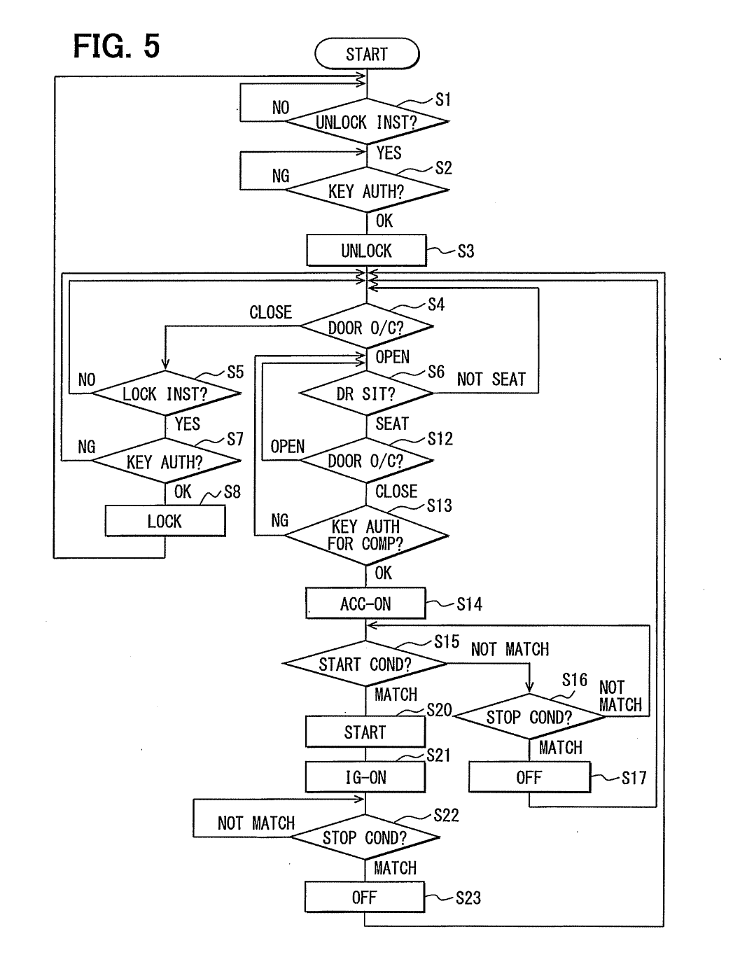

Next, FIG. 5 shows a flowchart of a process, which is executed by the control device 83 with respect to the power source controller 86. The process is repeatedly executed by the CPU in the control device 83 according to a program stored in a ROM of the control device 83 even when the car 1 stops and parks. As shown in FIG. 5, at step S1, the device 83 determines whether an unlock instruction is received from the ID authentication mobile device 19. When the unlock instruction is not received (i.e., the determination in step S1 is “NO”), it returns to step S1 so as to stand-by. When the unlock instruction is received (i.e., the determination in step S1 is “YES”), it proceeds to step S2. At step S2, the ID authentication in-vehicle device 69 authenticates the ID of a key of the car 1 (i.e., a key authentication is performed). When the key authentication is not proper (i.e., NG or no good), it returns to step S2 so as to stand-by. When the key authentication is proper (i.e., OK), it proceeds to step S3. At step S3, the door lock system 91 unlocks the door 2. Then, it proceeds to step S4.

At step S4, the door open/close detection device 52 determines whether the door 2 is opened or closed. Just after the door 2 is unlocked, the door 2 is not opened yet, so that the determination in step S4 is “CLOSE.” In this case, it proceeds to step S5. At step S5, it is determined whether a lock instruction of the door 2 is performed. Just after the unlock instruction is performed, the lock instruction is not performed yet, so that the determination in step S5 is “NO.” In this case, it goes to step S4. During a loop process between steps S4 and S5, the driver opens the door 2, so that the determination in step S4 is “OPEN.” In this case, it proceeds to step S6. At step S6, it is determined through the seating determination device 54 whether the driver sits down on the driver seat 4. Until the driver sits down on the seat 4, i.e., when the determination in step S6 is “NOT SEAT,” it proceeds to step S4. Thus, a loop process between steps S4 and A6 is performed. When the driver closes the door 2 without sitting down on the seat 4, and further, the ID authentication mobile device 19 sends the lock instruction (i.e., when the determination in step S6 is “NOT SEAT,” the determination in step S4 is “CLOSE,” and the determination in step S5 is “YES”), it goes to step S7, and at step S7, the key authentication is performed, similar to step S2. When the ID authentication is proper (i.e., when the determination in step S7 is “OK”), it goes to step S8, and at step S8, the door 2 is locked. Then, it proceeds to step S1. When the key authentication is not proper (i.e., when the determination in step S7 is “NG”), it goes to step S4.

During the loop process between steps S4 and S5, when the door 2 is opened, and the driver sits down on the seat 4 (i.e., when the determination in step S4 is “OPEN,” and the determination in step S6 is “SEAT”), it proceeds to step S12. At step S12, it is determined whether the door 2 is opened or closed. When the door 2 is opened, i.e., when the determination in step S12 is “OPEN,” it proceeds to step S6. In this case, a loop process between steps S6 and S12 is performed. During the loop process, when the door 2 is closed, i.e., when the determination in step S12 is “CLOSE,” it goes to step S13.

At step S13, it is determined whether the ID authentication mobile device 19 corresponding to the car 1 is disposed in the compartment of the car 1, i.e., a key authentication for compartment is performed. When the key authentication for compartment is not proper (i.e., when the determination in step S13 is “NG”), it goes to step S6. When the key authentication for compartment is proper (i.e., when the determination in step S13 is “OK”), it goes to step S14.

At step S14, the accessory power source 86A turns on, i.e., the accessory power source 86A is in the on-state (ACC-ON). Then, in step S15, it is determined whether a start condition is established. Specifically, the start condition includes that the belt fastening detection device 62 detects that the driver fastens the belt 12, the steering wheel gripping detection device 59 detects that the driver grips the steering wheel 9A, and a start permission state, which is a general start condition in a conventional vehicle, is established. The start permission sate is, for example, such that a shift lever position detection device 61 detects that the shift lever position is a P position (parking position) or a N position (neutral position) in case of an automatic transmission vehicle, and the brake pedal switch 57 detects that the driver puts on the brake pedal 7. The start permission state in case of a manual transmission vehicle is such that the driver puts on a clutch pedal.

Just after the driver sits down on the seat 4, when the start condition is not established, i.e., when the determination in step S15 is “NOT MATCH,” it goes to step S16. At step S16, it is determined whether a stop condition is established. The stop condition includes that the door open/close detection device 52 detects that the door 2 is opened, the seating detection device 54 detects that the seating state is switched to the not-seating state (i.e., the driver stands up from the seat 4), the belt fastening detection device 62 detects that the seat belt 12 is removed, and the shift lever position detection device 61 detects that the shift lever position is a P position or a N position in case of an automatic transmission vehicle. Just after the driver sits down on the seat 4, the stop condition is not established (i.e., the determination in step S16 is “NOT MATCH”). In this case, it goes to step S15.

Thus, the stop condition is established during the loop process between steps S15 and S16 when the driver get out of the car 1 and then closes the door 2. In this case, i.e., when the determination in step S16 is “MATCH,” it goes to step S17. At step S17, the accessory power source 86A turns off, i.e., the accessory power source 86A is in the off-state. Then, it goes to step S4. During the loop process between steps S15 and S16, when the driver starts to drive the car 1 so that the start condition is established (i.e., when the determination in step S15 is “MATCH”), it goes to step S20. At step S20, the ignition power source 86B turns on, i.e., the ignition power source 86B is in the on-state, and further, the engine system 85 starts. After the engine system 85 starts functioning, at step S21, the on-state of the ignition power source 86B is maintained. Then, at step S22, it is determined whether the stop condition is established, similar to step S16. Just after the engine system 85 starts when the start condition is established, the stop condition is not established, i.e., the determination in step S22 is “NOT MATCH.” In this case, the process returns to step S22 so as to stand-by. Thus, in the stand-by state at step S22, the driver can drive the car 1. When the driver parks the car 1 at a parking lot, and the driver opens the door 2, and get out of the car 1, the stop condition is established (i.e., the determination in step S22 is “MATCH”). In this case, it goes to step S23. At step S23, the accessory power source 86A and the ignition power source 86B turn off, and then, it goes to step S4.

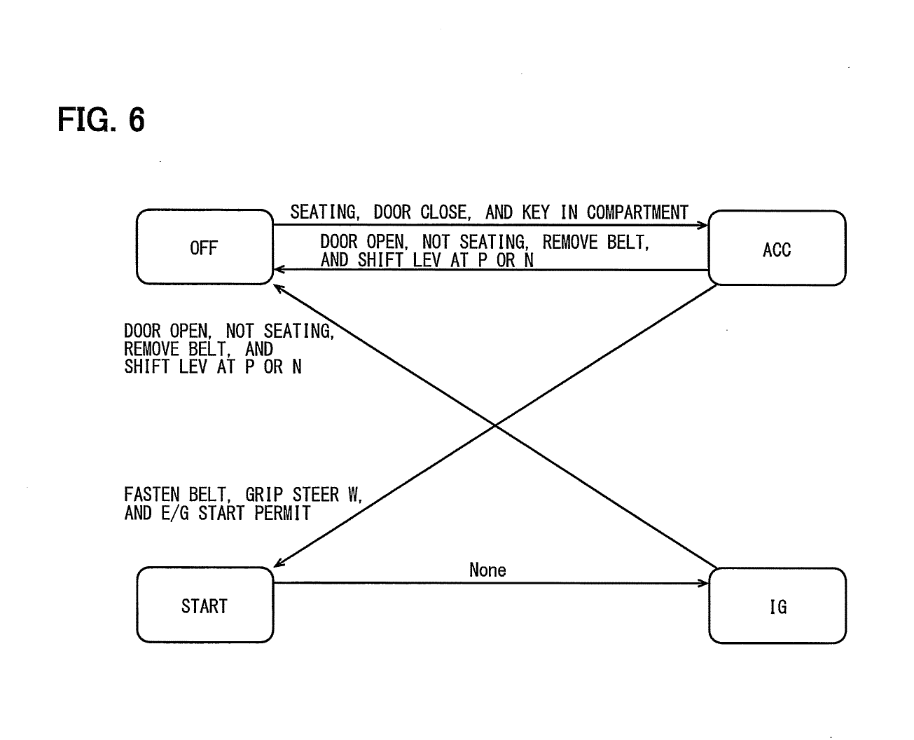

Thus, the state transition of the process is shown in FIG. 6. Specifically, when the driver is outside of the car 1, the accessory power source 86A and the ignition power source 86B turn off at step S1. From this situation, after the unlock instruction is performed and the key authentication is performed, when the driver sits down on the seat 4 (i.e., the determination at step S6 is “SEAT”), the door 2 is closed (i.e., the determination at step S12 is “CLOSE”), and the key authentication for compartment is performed (i.e., the determination at step S13 is “OK”), the accessory power source 86A turns on at step S14. In addition, the driver fastens the seat belt 12, grips the steering wheel 9A, and other engine start permission condition is met (i.e., the determination at step S15 is “MATCH”), the engine system 85 starts to run at step S20. After the engine system 85 starts, the on-state of the ignition power source 86B is maintained at step S21 even if the driver does not operate anything. After the driver parks the car 1, when the driver gets off the seat belt 12 so that the driver is not in a seating and fastening the seat belt on the seat 4, the shift lever position is arranged at the P position or the N position, and the driver opens the door 2 (i.e., the determination in step S22 is “MATCH”), the accessory power source 86A and the ignition power source 86B turn off at step S23.

Thus, when a preferable state for permitting usage of an in-vehicle device such as the navigation device 98 is established since the driver sits down on the seat 4 and the door 2 is closed, the accessory power source 86A automatically turns on without performing a special operation for turning on the power source. Further, when the driver fastens the seat belt 12 and grips the steering wheel 9A, so that the driver performs an action for starting to drive the car 1, the ignition power source 86B turns on without performing a special operation for turning on the power source. Accordingly, the power source operation is automatically performed so as to match the requirement of the driver, and therefore, the operability of the car 1 is much improved.

Further, since the condition for turning on each power source is determined by a combination of at least two detection results. Thus, a failure that the power source accidentally turns on against the driver's intention is appropriately restricted. Further, in the present embodiment, only a case where the ID is authenticated, i.e., the ID authentication is proper, the power source turns on. Thus, the security is much improved.

Further, in the present embodiment, when a not-preferable state for turning on each power source is established since the driver does not sit down on the seat 4 and the door 2 is opened, each power source automatically turns off.

Thus, the safety and fuel consumption are improved. Further, the stop condition for turning off each power source is determined by a combination of at least two detection results. Thus, a failure that the power source accidentally turns off against the driver's intention is appropriately restricted.

Here, in the present embodiment, the battery 90 and the power source controller 86 correspond to a power source or a power source unit. The door open/close detection device 52 corresponds to a door open and close detector. The seating detection device 54 corresponds to a seating detector. The belt fastening detection device 62 corresponds to a belt detector. The steering wheel gripping detection device 59 corresponds to a gripping detector. The brake pedal switch 57 corresponds to a brake detector. The shift lever position detection device 61 corresponds to a shift lever position detector. The control device 83 corresponds to a power source control device. The ID authentication in-vehicle device 69 corresponds to an authentication device. The ignition power source 86B corresponds to a vehicle driving power source. The door open/close detection device 52 and the seating detection device 54 correspond to a first detector.

(Modifications)

For example, in the above embodiment, when the stop condition is satisfied, each power source turns off immediately. Alternatively, even when the stop condition is satisfied, each power source does not turn off immediately. Instead, when the stop condition is continuously satisfied for a while, each power source may turn off. In this case, for example, when the determination at step S22 is “MATCH,” it goes to a step for determining whether a predetermined time interval has elapsed since the stop condition is established. When the predetermined time interval has elapsed, i.e., when the determination in step is “YES,” it goes to step S23. When the predetermined time interval does not have elapsed, i.e., when the determination in step is “NO,” it goes to step S22. In this case, a failure that the ignition power source 86B accidentally turns off against the driver's intention is appropriately restricted. The word “and” in the above described start condition and the above described stop condition may be replaced with “or.” Specifically, the start condition may include that the belt fastening detection device 62 detects that the driver fastens the belt 12, the steering wheel gripping detection device 59 detects that the driver grips the steering wheel 9A, or a start permission state, which is a general start condition in a conventional vehicle, is established. The stop condition may include that the door open/close detection device 52 detects that the door 2 is opened, the seating detection device 54 detects that the seating state is switched to the not-seating state (i.e., the driver stands up from the seat 4), the belt fastening detection device 62 detects that the seat belt 12 is removed, or the shift lever position detection device 61 detects that the shift lever position is a P position or a N position in case of an automatic transmission vehicle. When the word “and” in the above described stop condition is replaced with “or,” an advantage of a step for determining whether the predetermined time interval has elapsed since the stop condition is established is remarkably obtained. Further, the combination of each detection result for providing the stop condition and the start condition may be changed, and the condition for turning on the accessory power source 86A may be changed.

Alternatively, a speed sensor mounted on the car 1 may be connected to the control device 83, so that the ignition power source 86B does not turn off when the vehicle speed of the car 1 is equal to or larger than a predetermined speed. In this case, for example, when the determination in step S22 is “MATCH,” it goes to a step for determining whether the vehicle speed is less than the predetermine speed. When the vehicle speed is less than the predetermined speed, i.e., when the determination in step is “YES,” it goes to step S23. When the vehicle speed is not less than the predetermined speed, i.e., when the determination in step is “NO,” it goes to step S22. In this case, when the vehicle speed is equal to or larger than the predetermined speed so that it is not appropriate to turn off the ignition power source 86B, an operation for turning off the ignition power source 86B is restricted.

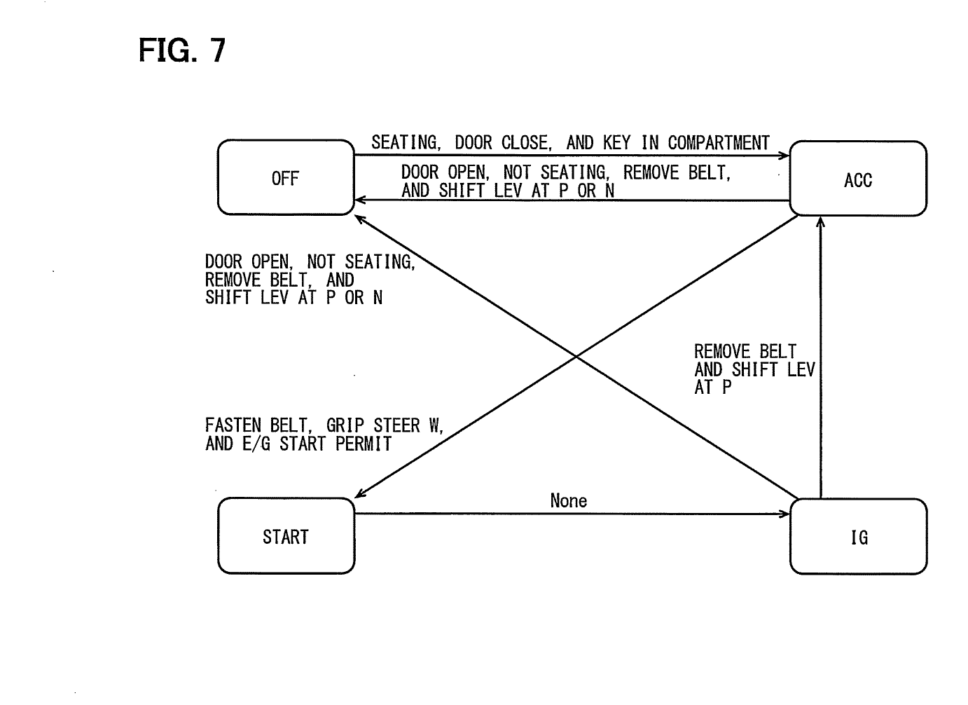

As shown in FIG. 7, under a condition that both of the accessory power source 86A and the ignition power source 86B turn on, when the shift lever position is changed to the P position, and the driver puts off seat belt 12, only the ignition power source 86B may turn off. In this case, for example, when the determination in step S22 is “NOT MATCH,” it goes to step for determining whether the shift lever position is changed to the P position, and the seat belt 12 is put off. When the shift lever position is changed to the P position, and the seat belt 12 is put off, i.e., when the determination in step is “YES,” the ignition power source 86B only turns off, and then, it goes to step S15. When the shift lever position is not changed to the P position, or the seat belt 12 is not put off, i.e., when the determination in step is “NO,” it goes to step S22. In this case, the condition for turning on the ignition power source 86B is largely different from the condition for turning off the ignition power source 86B, and therefore, the power source control for adapting to the requirement of the driver is performed.

Further, in the above embodiment, the engine system 85 may include an internal combustion engine. The ignition power source 86B supplied electricity to the engine system 85. Alternatively, the engine system 85 may be an HV (hybrid vehicle) system for a hybrid vehicle or a EV (electric vehicle) system for an electric vehicle. In this case, the start permission state for providing the start condition may be replaced to another start permission state, which corresponds to the hybrid vehicle or the electric vehicle.

In the present embodiment, a push type button is not described. However, the push type button may be utilized. For example, only when the ignition power source 86B turns on, the push type button may be utilized. Alternatively, when the above described control does not provide to start the engine, the push type button may be utilized accessorially. The authentication whether the driver is an owner of the car 1 may be performed by authenticating a face of the driver or finger print of the driver. Here, it is necessary to turn on the accessory power source 86A in order to activate a camera or the like for shooting an image of the face of the driver. Thus, if a process in step S13 is replaced to a step for authenticating the face or the like, at step S14, the accessory power source 86A preliminary turns on. Then, when the authentication of the face or the like is not valid, the accessory power source 86A turns off immediately, and then, it goes to step S6. When the authentication of the face or the like is valid, it goes to step S15. Alternatively, the ID authentication mobile device 19 may be a multi-function mobile terminal.

In the present embodiment, the vehicular power source control apparatus further includes an authentication device for authenticating whether the driver of the car 1 is the owner of the car. The power source control device controls the power source to turn on when the power source turn-on condition is met, and the authentication device authenticates that the driver is the owner of the car. In this case, only when the driver is the owner of the car, the power source turns on, so that the security of the car is much improved.

Further, at least two detection devices relating to the power source turn-on condition may provide a first detection device group. The apparatus further includes other detection devices, which do not belong to the first detection device group. The power source includes the accessory power source and the vehicle driving power source for driving the vehicle. The power source control device controls the accessory power source to turn on when the power source turn-on condition is satisfied. Further, when the start condition provided by at least two detection results, which are derived from at least one of the detection results of the other detection devices, is established, the vehicle driving power source may turn on. In this case, when the power source turn-on condition is established, the accessory power source turns on. Under this condition, when the start condition is further established, the vehicle driving power source may turn on. Accordingly, a condition for allowing the usage of the in-vehicle device such as the navigation device is different from a condition for allowing the drive of the vehicle, so that the power source control, which is adapted to the requirement of the driver, is performed.

In the above case, the detection device in the first detection device group or the other detection device may include at least the belt fastening detection device and the gripping detection device. The start condition may include at least the detection result of the belt detection device that the driver puts on the seat belt and the detection result of the gripping detection device that the driver grips the steering wheel. In this case, an operation of the vehicle, which starts to run against the driver's intention, is appropriately restricted.

In the above case, furthermore, the detection device in the first detection device or the other detection devices may include the shift lever. The start condition may include the detection result of the shift lever position detection device such that the shift lever position is the P position or the N position. In this case, an operation of the vehicle, which starts to run against the driver's intention, is appropriately restricted.

Furthermore, the detection device in the first detection device or the other detection devices may include the brake detection device. The start condition may include the detection result of the brake detection device such that the driver puts on the brake pedal. In this case, an operation of the vehicle, which starts to run against the driver's intention, is appropriately restricted. Here, the start condition may be provided by a combination of the detection results other than the above described detection results.

In the start condition, the power source control device may controls the vehicle driving power source to turn off when the stop condition provided by at least two detection results, which are preliminary set in accordance with the detection device in the first detection device group or the other detection devices, among the detection result of the door open/close detection device such that the door is opened, the detection result of the seating detection device such that the driver does not sit down on the seat, the detection result of the belt fastening detection device such that the driver puts off the seat belt, the detection result of the gripping detection device such that the driver does not grip the steering wheel, the detection result of the brake detection device such that the driver does not puts on the brake pedal, and the detection result of the shift lever position detection device such that the shift lever position is the P position or the N position, is established. In this case, under a condition that it is not appropriate to turn on the vehicle driving power source, the vehicle driving power source may automatically turn off, so that the safety and the fuel consumption are improved. Further, since the stop condition is provided by a combination of at least two detection results, an operation of the vehicle driving power source, which accidentally turns off against the driver's intention, is appropriately restricted.

In the above case, the detection device in the first detection device or the other detection devices may include the belt detection device and the seating detection device. The stop condition may include at least two detection results that are the detection result of the belt detection device such that the driver puts off the seat belt and the detection result of the seating detection device such that the driver does not sit down on the seat. In this case, an operation of the vehicle driving power source, which accidentally turns off against the driver's intention, is appropriately restricted.

Further, in the above case, the stop condition may include a condition for holding both of the detection result of the belt detection device such that the driver puts off the seat belt and the detection result of the seating detection device such that the driver does not sit down on the seat for a predetermine time interval. In this case, an operation of the vehicle driving power source, which accidentally turns off against the driver's intention, is appropriately restricted.

In the stop condition, the detection device in the first detection device or the other detection devices may include belt detection device and the shift lever position detection device. The stop condition may include at least two detection results that are the detection result of the belt detection device such that the driver puts off the seat belt and the detection result of the shift lever position detection device such that the shift lever position is the P position. In this case, an operation of the vehicle driving power source, which accidentally turns off against the driver's intention, is appropriately restricted.

Furthermore, in the above case, the stop condition may include a condition for holding both of the detection result of the belt detection device such that the driver puts off the seat belt and the detection result of the shift lever position detection device such that the shift lever position is the P position for a predetermine time interval. In this case, an operation of the vehicle driving power source, which accidentally turns off against the driver's intention, is appropriately restricted.

In the stop condition, the apparatus further includes a vehicle speed detection device for detecting the vehicle speed. The power source control device may control the vehicle driving power source to maintain the on-state regardless of the establishment of the stop condition when the vehicle speed detected by the vehicle speed detection device is equal to or larger than the predetermined speed. In this case, under a condition that it is not appropriate to turn off the vehicle driving power source since the vehicle speed of the vehicle is equal to or larger than the predetermined speed, the operation of the vehicle driving power source, which turns off, is appropriately restricted.

In the present embodiment, the power source includes the accessory power source and the vehicle driving power source for driving the vehicle. The at least two detection devices include the door open/close detection device and the seating detection device. The power source turn-on condition includes at least two conditions that are the detection result of the door open/close detection device such that the door is closed and the detection result of the seating detection device such that the driver sits down on the seat. The power source control device may control the accessory power source to turn on when the power source turn-on condition is established. In this case, when a condition for being capable of activating at least the in-vehicle device is established, for example, when the driver sits down on the seat and the door is closed, the accessory power source automatically turns on.

In the start condition, the detection device in the first detection device may include the door open/close detection device and the seating detection device. The power source turn-on condition may include at least two conditions that are the detection result of the door open/close detection device such that the door is closed and the detection result of the seating detection device such that the driver sits down on the seat. In this case, when a condition for being capable of activating at least the in-vehicle device is established, for example, when the driver sits down on the seat and the door is closed, the accessory power source automatically turns on.

In the present embodiment, when the driver sits down on the seat and the door is closed, the accessory power source may turn on. Further, when the shift lever position is the P position or the N position, and the driver sits down on the seat, grips the steering wheel, and puts on the brake pedal, the vehicle driving power source may turn on.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicular power source control apparatus mounted on a vehicle and controlling a power source of the vehicle comprising:
at least two detection devices selected from a door open and close detection device for detecting whether a door of the vehicle is opened or closed, a seating detection device for detecting whether a driver of the vehicle sits down on a driver seat, a belt detection device for detecting whether the driver fastens a seat belt, a gripping detection device for detecting whether the driver grips a steering wheel, a brake detection device for detecting whether the driver puts on a brake pedal, or a shift lever position detection device for detecting a shift lever position of the vehicle; and
a power source control device for controlling the power source to turn on when a power source turn-on condition is established, wherein:
the power source turn-on condition is provided by a combination of at least two predetermined detection results, which correspond to the at least two detection devices; and
the at least two predetermined detection results of the power source turn-on condition are selected from a detection result of the door open and close detection device such that the door is closed, a detection result of the seating detection device such that the driver sits down on the driver seat, a detection result of the belt detection device such that the driver fastens the seat belt, a detection result of the gripping detection device such that the driver grips the steering wheel, a detection result of the brake detection device such that the driver puts on the brake pedal, or a detection result of the shift lever position detection device such that the shift lever position of the vehicle is a parking position or a neutral position.

2. The vehicular power source control apparatus according to claim 1, further comprising:
an authentication device for authenticating whether the driver is an owner of the vehicle, wherein:
the power source control device controls the power source to turn on when the power source turn-on condition is established, and the authentication device authenticates that the driver is an owner of the vehicle.

3. The vehicular power source control apparatus according to claim 1, wherein:
the at least two detection devices are defined as a first detection device group;
a second detection device group includes at least one detection device, which is not selected as the first detection device group from the door open and close detection device, the seating detection device, the belt detection device, the gripping detection device, the brake detection device, or the shift lever position detection device;
the power source includes an accessory power source and a vehicle driving power source for driving the vehicle;
the power source control device controls the accessory power source to turn on when the power source turn-on condition is established;
the power source control device controls the vehicle driving power source to turn on when the power source turn-on condition is established, and a start condition is established; and
the start condition is provided by a combination of at least two predetermined detection results, which include a detection result of the at least one detection device in the second detection device group.

4. The vehicular power source control apparatus according to claim 3, wherein:
the at least two detection devices in the first detection device group or the at least one detection device in the second detection device group include at least the belt detection device and the gripping detection device;
the at least two predetermined detection results for providing the start condition include the detection result of the belt detection device such that the driver, fastens the seat belt and the detection result of the gripping detection device such that the driver grips the steering wheel.

5. The vehicular power source control apparatus according to claim 4, wherein:
the at least two detection devices in the first detection device group or the at least one detection device in the second detection device group further include the shift lever position detection device; and
the at least two predetermined detection results for providing the start condition further include the detection result of the shift lever position detection device such that the shift lever position of the vehicle is the parking position or the neutral position.

6. The vehicular power source control apparatus according to claim 4, wherein:
the at least two detection devices in the first detection device group or the at least one detection device in the second detection device group further include the brake detection device; and
the at least two predetermined detection results for providing the start condition further include the detection result of the brake detection device such that the driver puts on the brake pedal.

7. The vehicular power source control apparatus according to claim 3, wherein:
the power source control device controls the vehicle driving power source to turn off when a stop condition is established;
the stop condition is provided by a combination of at least two predetermined detection results, which correspond to the at least two detection devices in the first detection device group or the at least one detection device in the second detection device group; and
the at least two predetermined detection results for providing the stop condition are selected from a detection result of the door open and close detection device such that the door is opened, a detection result of the seating detection device such that the driver does not sit down on the driver seat, a detection result of the belt detection device such that the driver unfastens the seat belt, a detection result of the gripping detection device such that the driver does not grip the steering wheel, a detection result of the brake detection device such that the driver does not put on the brake pedal, or a detection result of the shift lever position detection device such that the shift lever position of the vehicle is a parking position or a neutral position.

8. The vehicular power source control apparatus according to claim 7, wherein:
the at least two detection devices in the first detection device group or the at least one detection device in the second detection device group include the belt detection device and the seating detection device;
the at least two predetermined detection results for providing the stop condition include the detection result of the seating detection device such that the driver does not sit down on the driver seat and the detection result of the belt detection device such that the driver unfastens the seat belt.

9. The vehicular power source control apparatus according to claim 8, wherein:
the stop condition further includes a condition that the detection result of the seating detection device such that the driver does not sit down on the driver seat and the detection result of the belt detection device such that the driver unfastens the seat belt continue for a predetermined time interval.

10. The vehicular power source control apparatus according to claim 7, wherein:
the at least two detection devices in the first detection device group or the at least one detection device in the second detection device group include the belt detection device and the shift lever position detection device; and
the at least two predetermined detection results for providing the stop condition include the detection result of the belt detection device such that the driver unfastens the seat belt and the detection result of the shift lever position detection device such that the shift lever position of the vehicle is the parking position.

11. The vehicular power source control apparatus according to claim 10, wherein:
the stop condition further includes a condition that the detection result of the belt detection device such that the driver unfastens the seat belt and the detection result of the shift lever position detection device such that the shift lever position of the vehicle is the parking position continues for a predetermined time interval.

12. The vehicular power source control apparatus according to claim 7, further comprising:
a vehicle speed detection device for detecting a vehicle speed, wherein:
the power source control device controls the vehicle driving power source to continue to turn on regardless of an establishment of the stop condition when the vehicle speed detected by the vehicle speed detection device is equal to or larger than a predetermined speed.

13. The vehicular power source control apparatus according to claim 1, wherein:
the power source includes an accessory power source and a vehicle driving power source for driving the vehicle;
the at least two detection devices includes the door open and close detection device and the seating detection device;
the at least two predetermined detection results for providing the start condition include the detection result of the door open and close detection device such that the door is closed and the detection result of the seating detection device such that the driver sits down on the driver seat; and
the power source control device controls the accessory power source to turn on when the power source turn-on condition is established.

14. The vehicular power source control apparatus according to claim 3, wherein:
the at least two detection devices in the first detection device group includes the door open and close detection device and the seating detection device; and
the at least two predetermined detection results for providing the start condition include the detection result of the door open and close detection device such that the door is closed and the detection result of the seating detection device such that the driver sits down on the driver seat.
